(19) United States
(12) Patent Application Publication
(10) Pub. No.: US 2010/0246461 A1
(43) Pub. Date: Sep. 30, 2010

(54) POWER SAVING METHOD FOR WIRELESS ACCESS POINT

(75) Inventors: KAI HSIANG HSIEH, HSINCHU COUNTY (TW); MING TA LI, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/550,695

(22) Filed: Aug. 31, 2009

(30) Foreign Application Priority Data
Mar. 24, 2009 (TW) 098109449

(51) Int. Cl. G08C 17/00

(52) U.S. Cl. 370/311

(57) ABSTRACT

A power saving method for a wireless access point comprises the steps of detecting whether all wireless communication devices connected to the wireless access point are legacy apparatuses; and if affirmative, retaining one antenna for operation and disabling all other antennas.

### BACKGROUND OF THE INVENTION

1. Field of the Invention

The present invention relates to a power saving method, and more particularly to a power saving method for a wireless access point.

2. Description of the Related Art

With rapid developments in mobile communication technology, demand for communication service continues to increase, and improvements in bandwidth efficiency and communication quality are important issues in current communication systems. Wireless communication systems can be classified based on the number of transmitter and receiver antennas as one of the following: single input single output (SISO), single input multiple output (SIMO), multiple input single output (MISO), or multiple input multiple output (MIMO). FIG. 1 shows a block diagram of a conventional wireless local area network (WLAN) 10. The WLAN 10 comprises a station 11 and a wireless access point (AP) 12. The station 11 and the wireless AP 12 each comprises at least two transmitter and receiver antennas for communication. The station 11 or the wireless AP 12 using a plurality of transmitter and receiver antennas is described as a MIMO system. Because it provides a plurality of wireless channels, a MIMO system provides higher transmission capability and communication efficiency than a single input or single output system.

The 802.11n protocol, a new extension of the IEEE 802.11 standard, adopts a MIMO antenna structure as its core technology. The MIMO antenna structure improves the signal cover range and increases the signal strength and stability by using multiple antennas for signal transmission and reception.

Under the 802.11n protocol, the data transmission rate of the physical layer is as high as 600 Mbps and the efficiency of the MAC layer is improved by the frame aggregation function. Also, 802.11n devices provide backward compatibility with legacy 802.11 a/b/g devices.

However, because multiple antennas operate simultaneously when the wireless AP 12 utilizes the MIMO antenna structure, the power consumption is several times greater than the legacy 802.11 a/b/g apparatus using only a single antenna. Therefore, it is desirable to provide a power saving method for a wireless access point to reduce power consumption when the wireless AP 12 utilizes the MIMO antenna structure.

### SUMMARY OF THE INVENTION

An aspect of the present invention is to provide a power saving method for a wireless access point, wherein the wireless access point has a plurality of antennas. The power saving method for a wireless access point of the present invention retains one antenna for operation and disables other antennas during a detection process so as to reduce the power consumption of the wireless access point.

According to one embodiment of the present invention, the power saving method for the wireless access point comprises detecting whether all stations or other wireless access points connected to the wireless access point are legacy apparatuses; and if affirmative, retaining one antenna for operation and disabling all other antennas.

According to another embodiment of the present invention, the power saving method for the wireless access point comprises detecting whether the wireless access point connects to any station or other wireless access point; and if negative, retaining one antenna for operation and disabling all other antennas.

According to yet another embodiment of the present invention, the power saving method for the wireless access point comprises detecting whether all stations or other wireless access points connected to the wireless access point use a single antenna; and if affirmative, retaining one antenna for operation and disabling all other antennas.

### BRIEF DESCRIPTION OF THE DRAWINGS

The invention will be described according to the appended drawings in which:

FIG. 1 shows a block diagram of a conventional wireless local area network;

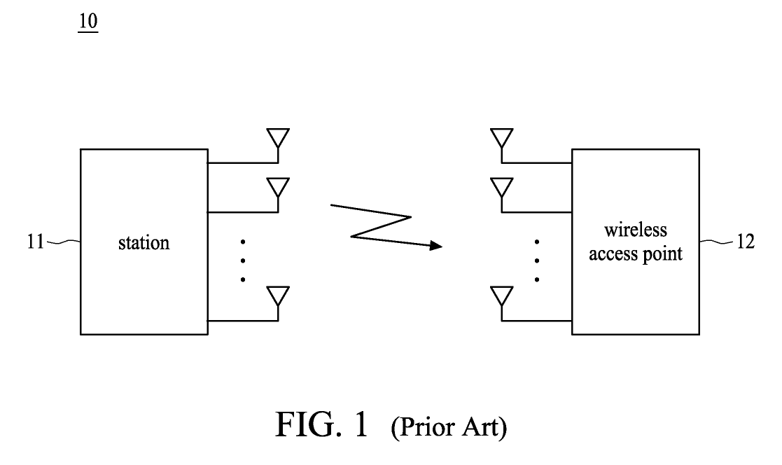

FIG. 2 shows a WLAN according to one embodiment of the present invention;

FIG. 3 shows a flow chart of the power saving method for a wireless access point according to one embodiment of the present invention;

FIG. 4 shows a flow chart of the power saving method for a wireless access point according to another embodiment of the present invention;

FIG. 5 illustrates a circumstance in which a station roams from the communication range of a first wireless AP to the communication range of a second AP; and

FIG. 6 shows a flow chart of the power saving method for a wireless access point according to yet another embodiment of the present invention.

### DETAILED DESCRIPTION OF THE INVENTION

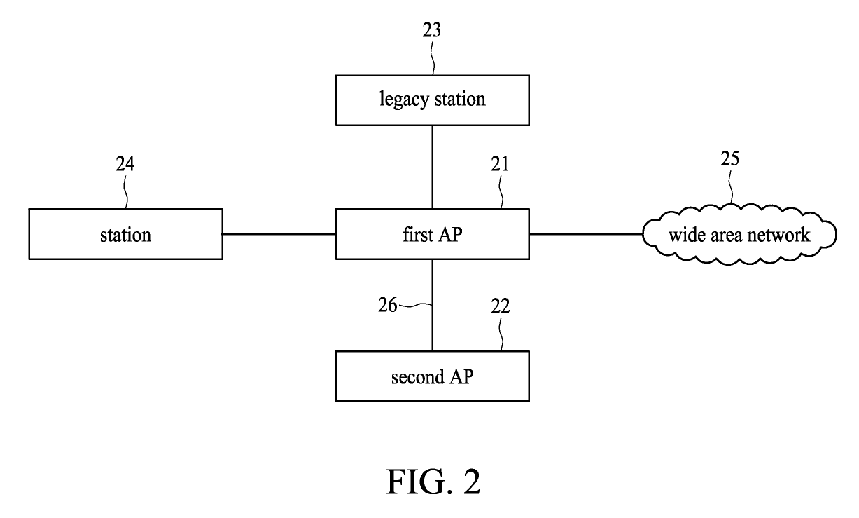

In order to explain the power saving method for a wireless access point of the present invention more clearly, a wireless communication system will be described that utilizes the method of the present invention. FIG. 2 shows a WLAN according to one embodiment of the present invention. The WLAN comprises a first wireless AP 21, a legacy station 23, and a station 24. The first wireless AP 21 and the station 24 are 802.11n compliant apparatuses. The first wireless AP 21 or the station 24 comprises a plurality of antennas for transmitting and receiving signals. The legacy station 23 is an 802.11a, 802.11b or 802.11g compliant apparatus with a single antenna. The WLAN connects to a wide area network 25 via the first wireless AP 21. The wide area network 25 may be the Internet. A second wireless AP 22 is located in the area and the first wireless AP 21 connects to the second wireless AP 22 via a communication chain 26 to form a mesh type network.

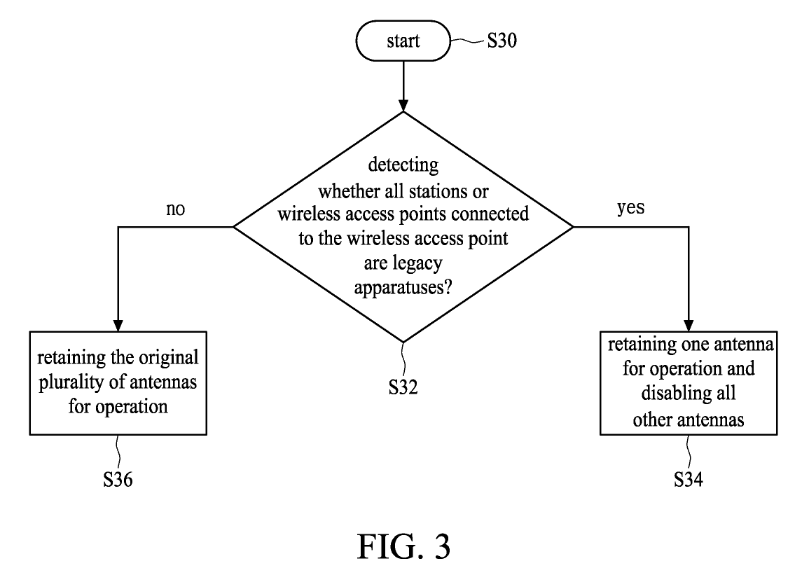

FIG. 3 shows the flow chart of the power saving method for a wireless access point according to one embodiment of the present invention. In step S30, the wireless access point proceeds to utilize the power saving method. In step S32, the wireless access point detects whether all stations or other wireless access points connected to the wireless access point are legacy apparatuses. If affirmative, then the wireless access point retains one antenna for operation and disables all other antennas. If negative, then the wireless access point retains the original plurality of antennas for operation in step S36. The details of the power saving method for a wireless access point of the present invention are described in accordance with FIG. 2.

Initially, the first wireless AP 21 detects whether stations or wireless access points connected to it are all legacy apparatuses. As mentioned above, the legacy apparatus is an 802.11a, 802.11b or 802.11g compliant apparatus, such as the legacy station 23 with single antenna shown in FIG. 2. If the stations or the wireless access points connected to the first wireless AP 21 are all legacy apparatuses, the first wireless AP 21 uses one antenna to receive or transmit messages from legacy apparatuses. The term “connected,” as used herein, indicates that wireless communication is opened between a wireless access point and a station, or between one wireless access point and another wireless access point by a wireless medium, such as a link.

Next, if the stations connected to the first wireless AP 21 are all legacy apparatuses, then the first wireless AP 21 retains one antenna for operation and disables all other antennas. Disabling other antennas is effected by disabling clock signals of a media access controller (MAC) and a baseband processor (BBP) to which other antennas correspond. The MAC and the BBP are located in a system of chip (SOC) in the first wireless AP 21. The MAC is used to implement a MAC layer processing of the first wireless AP 21 and the BBP is used, among other functions, to analyze the data from the first wireless AP 21 and generate the data transmitting to the MAC layer. If one of the stations or wireless access points connected to the first wireless AP 21 is not a legacy apparatus, the first wireless AP 21 retains the original plurality of antennas for operation.

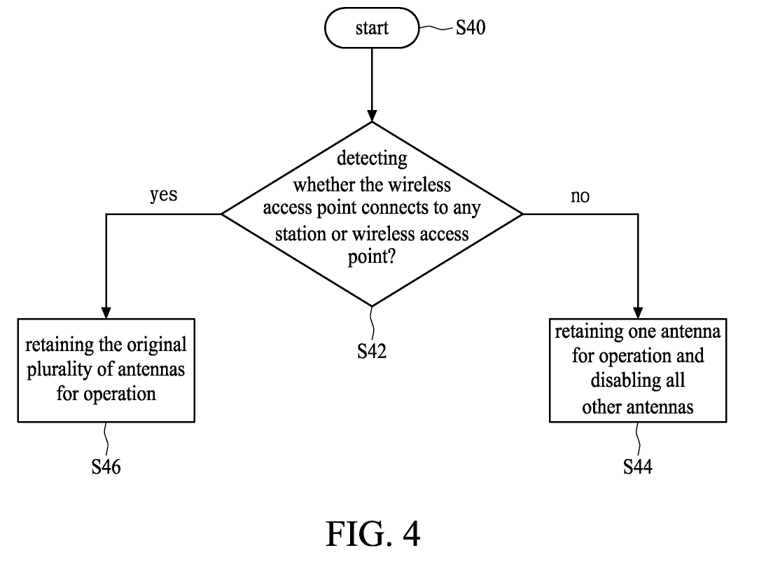

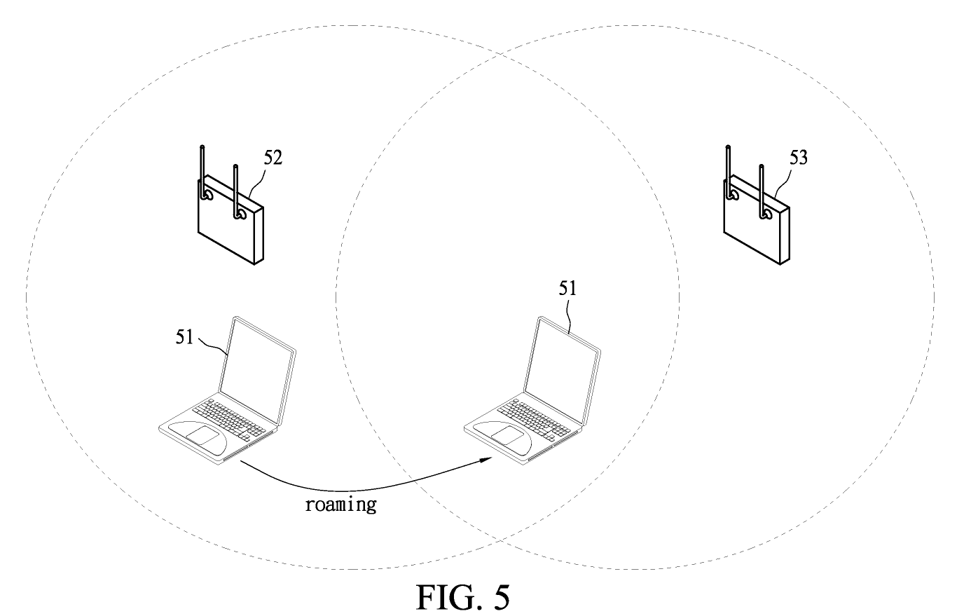

FIG. 4 shows the flow chart of another embodiment of the power saving method for a wireless access point of the present invention. In step S40, the wireless access point starts to utilize the power saving method. In step S42, the wireless access point detects whether the wireless access point connects to any station or wireless access point. If negative, then the wireless access point retains one antenna for operation and disables all other antennas. If affirmative, then the wireless access point retains the original plurality of antennas for operation in step S46. FIG. 5 describes the details of the power saving method for a wireless access point of the present invention.

FIG. 5 illustrates a circumstance in which a station 51 roams from the communication range of a first wireless AP 52 to the communication range of a second wireless AP 53. The station 51 is an 802.11n compliant apparatus. For the roaming, before the station 51 can be connected with the second wireless AP 53, a handoff procedure has to be performed. The handoff procedure includes a scanning phase, an authentication phase and a re-association phase. The scanning phase is classified as either active scanning or passive scanning. For passive scanning, the second wireless AP 53 sends a beacon frame periodically to inform the station 51 that there is a wireless access point in the area. The transmission of the beacon frame can be implemented by a single antenna, and thus only one antenna is retained for operation during the detection. Retaining one antenna for operation and disabling other antennas reduces power consumption. In addition, disabling other antennas is effected by disabling clock signals of a media access controller (MAC) and a baseband processor (BBP) to which other antennas correspond. If the second wireless AP 53 detects that the station 51 wants to associate with it, the second wireless AP 53 retains the original plurality of antennas for operation.

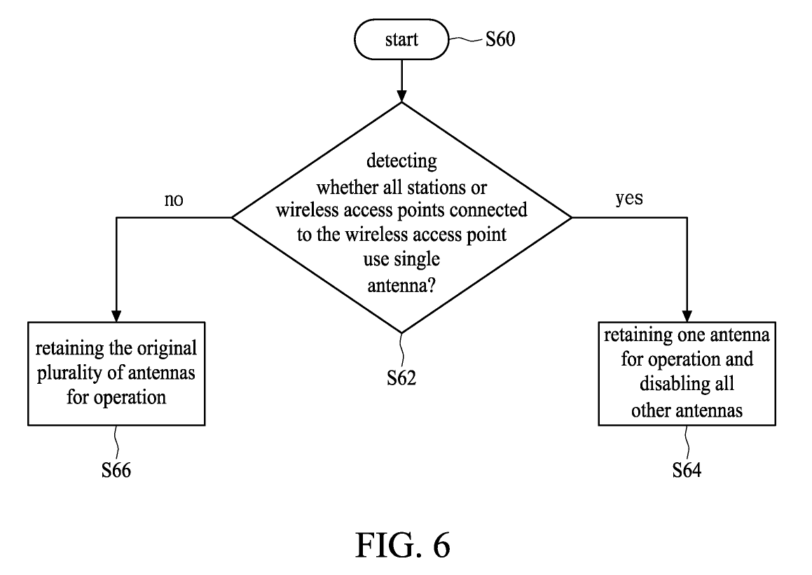

FIG. 6 shows the flow chart of the power saving method for a wireless access point of yet another embodiment of the present invention. In step S60, the wireless access point starts to utilize the power saving method. In step S62, the wireless access point detects whether all stations or other wireless access points connected to the wireless access point use a single antenna. If affirmative, then the wireless access point retains one antenna for operation and disables all other antennas in step S64. If negative, then the wireless access point retains the original plurality of antennas for operation in step S66. The details of the power saving method for wireless access point of the present invention are described in accordance with FIG. 2.

In one embodiment, a station or a wireless access point connected to the first wireless AP 21 is an 802.11n compliant apparatus, such as the station 24 with a plurality of antennas shown in FIG. 2. If the station 24 uses only one antenna for transmitting and receiving signals in a power saving mode, or in other situations, then the first wireless AP 21 retains one antenna for operation and disables all other antennas. In this embodiment, disabling other antennas is effected by disabling clock signals of a media access controller (MAC) and a baseband processor (BBP) to which other antennas correspond.

In summary, the power saving method for a wireless access point of the present invention detects the use of the antennas of a station or a wireless access point connected to the present wireless access point via a detection process. The power saving method for a wireless access point of the present invention retains one antenna for operation and disables other antennas during the detection process so as to reduce the power consumption of the present wireless access point.

The above-described embodiments of the present invention are intended to be illustrative only. Numerous alternative embodiments may be devised by those skilled in the art without departing from the scope of the following claims.

What is claimed is:

1. A power saving method for a wireless access point having a plurality of antennas, the method comprising the steps of:
detecting whether all wireless communication devices connected to the wireless access point are legacy apparatuses; and
if affirmative, retaining one antenna for operation and disabling all other antennas.

2. The power saving method of claim 1, wherein the step of disabling other antennas is performed by disabling clock signals of a media access controller and a baseband processor to which other antennas correspond.

3. The power saving method of claim 1, wherein the legacy apparatuses are IEEE 802.11a, 802.11b, or 802.11g compliant apparatuses.

4. The power saving method of claim 1, wherein the wireless access point is an IEEE 802.11n compliant apparatus.

5. The power saving method of claim 1, further comprising the step of:
if any station or any external wireless access point connected to the wireless access point is not a legacy apparatus, retaining original operations of the plurality of antennas of the wireless access point.

6. A power saving method for a wireless access point having a plurality of antennas, the method comprising the steps of:
detecting whether the wireless access point does not connect to any wireless communication device; and
if affirmative, retaining one antenna for operation and disabling all other antennas.

7. The power saving method of claim 6, wherein the step of disabling other antennas is performed by disabling clock signals of a media access controller and a baseband processor to which the other antennas correspond.

8. The power saving method of claim 6, wherein the detecting step comprises the step of sending a beacon frame periodically to inform the wireless communication device of the location of the wireless access point.

9. The power saving method of claim 6, wherein the wireless communication device is an IEEE 802.11n compliant apparatus.

10. The power saving method of claim 6, wherein the wireless access point is an IEEE 802.11n compliant apparatus.

11. A power saving method for a wireless access point having a plurality of antennas, the method comprising the steps of:
detecting whether all wireless communication devices connected to the wireless access point use a single antenna; and
if affirmative, retaining one antenna for operation and disabling all other antennas.

12. The power saving method of claim 11, wherein the step of disabling other antennas is performed by disabling clock signals of a media access controller and a baseband processor to which the other antennas correspond.

13. The power saving method of claim 11, wherein the wireless communication devices are IEEE 802.11n compliant apparatuses.

14. The power saving method of claim 11, wherein the wireless access point is an IEEE 802.11n compliant apparatus.

15. The power saving method of claim 11, further comprising the step of:
if the wireless communication devices use a plurality of antennas, retaining original operations of the plurality of antennas of the wireless access point.

16. The power saving method of claim 11, wherein the wireless communication devices have a plurality of antennas and are operated in a power saving mode.
